(19) United States
(12) Patent Application Publication
(10) Pub. No.: US 2007/0037729 A1
(43) Pub. Date: Feb. 15, 2007

(54) POWDERED CLEANING COMPOSITIONS

(75) Inventor: Dilip Mathur, East Brunswick, NJ (US)

Correspondence Address: Andrew N. Parfomak;Norris McLaughlin & Marcus PA, 18th Floor, 875 Third Avenue, New York, NY, 10022, US

(73) Assignee: Reckitt Benckiser Inc., Parsippany, NJ (US)

(21) Appl. No.: 11/464,301

(22) Filed: Aug. 14, 2006

Related U.S. Application Data
(60) Provisional application No. 60/707,757, filed on Aug. 12, 2005.

(51) Int. Cl. C11D 3/02

(52) U.S. Cl. 510/507

(57) ABSTRACT

Improved powdered hard surface cleaning compositions, having good dry flow properties and minimal caking are provided. Preferred compositions comprise one or more surfactants especially anhydrous or powdered anionic surfactants providing good foaming, calcium carbonate, and may exclude one or both of alkali or alkali metal bicarbonates, and known-art anti-caking constituents based on silica particles including colloidal silicas, fumed silicas, precipitated silicas and silica gels.

The present invention relates to improved powdered cleaning compositions. More particularly the compositions of the present invention are directed to improved powdered cleaning compositions which are particularly useful in the cleaning of hard surfaces.

Powdered cleaning compositions are known in the art. Powdered cleaning compositions are convenient to use, are typically storage stable and do not suffer from certain of the technical shortcomings associated with liquid compositions, e.g., phase separation, especially following freeze/thaw cycles. Thus there remains continued consumer interest as well as technical interest in providing further improved powdered cleaning compositions.

It is an object of the present invention to provide improved powdered cleaning compositions.

It is a further object of the invention to provide methods for the cleaning of hard surfaces, particularly lavatory appliances.

It is a further object of the invention to provide methods for the cleaning of hard surfaces, particularly kitchen surfaces and appliances.

These and other objects of the invention will become apparent from a reading of the following specification and consideration of the examples.

In one aspect of the invention there is provided a powdered hard surface cleaning composition which is particularly useful in the cleaning treatment of hard surfaces when wetted. The compositions may be added to water, or alternately water may be added to the powdered hard surface cleaning composition.

In another aspect of the invention there are provided methods for the manufacture of, and for the use of improved powdered hard surface cleaning compositions.

In a further aspect of the invention there is provided an improved method for the cleaning of hard surfaces, particularly lavatory appliances, e.g., the bowls of toilets, which method includes the step of: adding a quantity of the powder hard surface cleaning composition.

The inventive compositions necessarily include a surfactant constituent which includes one surfactants which may be used to provide a cleaning benefit to hard surfaces. Such may be one or more anionic, nonionic, cationic, amphoteric or zwitterionic surfactants as well as mixtures thereof. Known art surfactants may be used in the pulverent (powdered) compositions taught herein.

Exemplary useful anionic surfactants include alcohol sulfates and sulfonates, alcohol phosphates and phosphonates, alkyl ester sulfates, alkyl diphenyl ether sulfonates, alkyl sulfates, alkyl ether sulfates, sulfate esters of an alkylphenoxy polyoxyethylene ethanol, alkyl monoglyceride sulfates, alkyl sulfonates, alkyl ether sulfates, alpha-olefin sulfonates, beta-alkoxy alkane sulfonates, alkyl ether sulfonates, ethoxylated alkyl sulfonates, alkylaryl sulfonates, alkylaryl sulfates, alkyl monoglyceride sulfonates, alkyl carboxylates, alkyl ether carboxylates, alkyl alkoxy carboxylates having 1 to 5 moles of ethylene oxide, alkylpolyglycolethersulfates (containing up to 10 moles of ethylene oxide), sulfosuccinates, octoxynol or nonoxynol phosphates, taurates, fatty taurides, fatty acid amide polyoxyethylene sulfates, acyl glycerol sulfonates, fatty oleyl glycerol sulfates, alkyl phenol ethylene oxide ether sulfates, paraffin sulfonates, alkyl phosphates, isethionates, N-acyl taurates, alkyl succinamates and sulfosuccinates, alkylpolysaccharide sulfates, alkylpolyglucoside sulfates, alkyl polyethoxy carboxylates, and sarcosinates or mixtures thereof

Further examples of anionic surfactants include water soluble salts or acids of the formula (ROSO₃)ₓM or (RSO₃)ₓM wherein R is preferably a C₆-C₂₄ hydrocarbyl, preferably an alkyl or hydroxyalkyl having a C₁₀-C₂₀ alkyl component, more preferably a C₁₂-C₁₈ alkyl or hydroxyalkyl, and M is H or a mono-, di- or tri-valent cation, e. g., an alkali metal cation (e. g., sodium, potassium, lithium), or ammonium or substituted ammonium (e. g., methyl-, dimethyl-, and trimethyl ammonium cations and quaternary ammonium cations, such as tetramethyl-ammonium and dimethyl piperdinium cations and quaternary ammonium cations derived from alkylamines such as ethylamine, diethylamine, triethylamine, and mixtures thereof, and the like) and x is an integer, preferably 1 to 3, most preferably 1. Further examples anionic surfactants include alkyl-diphenyl-ethersulphonates and alkyl-carboxylates. Other anionic surfactants can include salts (including, for example, sodium, potassium, ammonium, and substituted ammonium salts such as mono-, di-and triethandlamine salts) of soap, C₆-C₂₀ linear alkylbenzenesulfonates, C₆-C₂₂ primary or secondary alkanesulfonates, C₆-C₂₄ olefinsulfonates, sulfonated polycarboxylic acids prepared by sulfonation of the pyrolyzed product of alkaline earth metal citrates, C₆-C₂₄ alkylpolyglycolethersulfates (containing up to 10 moles of ethylene oxide); alkyl ester sulfates such as C₁₄-₁₆ methyl ester sulfates; acyl glycerol sulfonates, fatty oleyl glycerol sulfates, alkyl phenol ethylene oxide ether sulfates, paraffin sulfonates, alkyl phosphates, isethionates such as the acyl isethionates, N-acyl taurates, alkyl succinamates and sulfosuccinates, monoesters of sulfosuccinate (especially saturated and unsaturated C₁₂-C₁₈ monoesters) diesters of sulfosuccinate (especially saturated and unsaturated C₆-C₁₄ diesters), acyl sarcosinates, sulfates of alkylpolysaccharides such as the sulfates of alkylpolyglucoside (the nonionic nonsulfated compounds being described below), branched primary alkyl sulfates, alkyl polyethoxy carboxylates such as those of the formula RO(CH₂CH₂O)ₖCH₂COO⁻M⁺ wherein R is a C₈-C₂₂ alkyl, k is an integer from 0 to 25, and M is a soluble salt-forming cation. Resin acids and hydrogenated resin acids are also suitable, such as rosin, hydrogenated rosin, and resin acids and hydrogenated resin acids present in or derived from tall oil.

Useful surfactants in the powdered compositions include sarcosinate surfactants which are alkali metal salts of N-alkyl-N-acyl amino acids. These are salts derived from the reaction of (1) N-alkyl substituted amino acids of the formula:
R₁—NH—CH₂—COOH
where R₁ is a linear or branched chain lower alkyl of from 1 to 4 carbon atoms, especially a methyl, for example, aminoacetic acids such as N-methylaminoacetic acid (i.e. N -methyl glycine or sarcosine), N-ethyl-aminoacetic acid, N-butylaminoacetic acid, etc., with (2) saturated natural or synthetic fatty acids having from 8 to 18 carbon atoms, especially from 10 to 14 carbon atoms, e.g. lauric acid, and the like.

The resultant reaction products are salts which may have the formula: 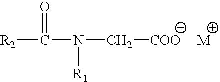
where M is an alkali metal ion such as sodium, potassium or lithium; R₁ is as defined above; and wherein R₂ represents a hydrocarbon chain, preferably a saturated hydrocarbon chain, having from 7 to 17 carbon atoms, especially 9 to 13 carbon atoms of the fatty acyl group.

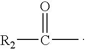

Exemplary useful sarcosinate surfactants include cocoyl sarcosinate, lauroyl sarcosinate, myristoyl sarcosinate, palmitoyl sarcosinate, stearoyl sarcosinate and oleoyl sarcosinate, and tallow sarcosinate. Such materials are also referred to as N-acyl sarcosinates.

Other anionic surfactants, although not particularly elucidated herein may also be considered for use in the present inventive compositions.

Exemplary nonionic surfactants which may find use in the present invention include known art nonionic surfactant compounds. Practically any hydrophobic compound having a carboxy, hydroxy, amido, or amino group with a free hydrogen attached to the nitrogen can be condensed with ethylene oxide or with the polyhydration product thereof, polyethylene glycol, to form a water soluble nonionic surfactant compound. Further, the length of the polyethylenoxy hydrophobic and hydrophilic elements may various. Exemplary nonionic compounds include the polyoxyethylene ethers of alkyl aromatic hydroxy compounds, e.g., alkylated polyoxyethylene phenols, polyoxyethylene ethers of long chain aliphatic alcohols, the polyoxyethylene ethers of hydrophobic propylene oxide polymers, and the higher alkyl amine oxides.

Illustrative examples of suitable nonionic surfactants include, inter alia, condensation products of alkylene oxide groups with an organic hydrophobic compound, such as an aliphatic compound or with an alkyl aromatic compound. The nonionic synthetic organic detergents generally are the condensation products of an organic aliphatic or alkyl aromatic hydrophobic compound and hydrophilic ethylene oxide groups. Practically any hydrophobic compound having a carboxy, hydroxy, amido, or amino group with a free hydrogen attached to the nitrogen can be condensed with ethylene oxide or with the polyhydration product thereof, polyethylene glycol, to form a water soluble nonionic detergent. Further, the length of the polyethenoxy hydrophobic and hydrophilic elements may be varied to adjust these properties. Illustrative examples of such a nonionic surfactants include the condensation product of one mole of an alkyl phenol having an alkyl group containing from 6 to 12 carbon atoms with from about 5 to 25 moles of an alkylene oxide. Another example of such a nonionic surfactant is the condensation product of one mole of an aliphatic alcohol which may be a primary, secondary or tertiary alcohol having from 6 to 18 carbon atoms with from 1 to about 10 moles of alkylene oxide. Preferred alkylene oxides are ethylene oxides or propylene oxides which may be present singly, or may be both present.

Still further illustrative examples of nonionic surfactants include primary and secondary linear and branched alcohol ethoxylates, such as those based on C₆-C₁₈ alcohols which further include an average of from 2 to 80 moles of ethoxylation per mol of alcohol. Examples include the Genapol® series of linear alcohol ethoxylates from Clariant Corp., Charlotte, N.C. Further examples of useful nonionic surfactants include secondary C₁₂-C₁₅ alcohol ethoxylates, including those which have from about 3 to about 10 moles of ethoxylation. Such are available in the Tergitol® series of nonionic surfactants (Dow Chemical, Midland, Mich.), particularly those in the Tergitol® “15-S-” series. Further exemplary nonionic surfactants include linear primary C₁₁-C₁₅ alcohol ethoxylates, including those which have from about 3 to about 10 moles of ethoxylation. Such are available in the Tomadol® (ex. Tomah Inc.) series of nonionic surfactants. Yet further examples of useful nonionic surfactants include C₆-C₁₅ straight chain alcohols ethoxylated with about 1 to 13 moles of ethylene oxide, particularly those which include about 3 to about 6 moles of ethylene oxide. Examples of such nonionic surfactants include Alfonic® 810-4.5, which is described as having an average molecular weight of 356, an ethylene oxide content of about 4.85 moles and an HLB of about 12; Alfonic® 810-2, which is described as having an average molecular weight of 242, an ethylene oxide content of about 2.1 moles and an HLB of about 12; and Alfonic® 610-3.5, which is described as having an average molecular weight of 276, an ethylene oxide content of about 3.1 moles, and an HLB of 10.

Further examples of suitable nonionic surfactants include alkyl glucosides, alkyl polyglucosides and mixtures thereof. Alkyl glucosides and alkyl polyglucosides can be broadly defined as condensation articles of long chain alcohols, e.g., C₈-C₃₀ alcohols, with sugars or starches or sugar or starch polymers i.e., glycosides or polyglycosides. These compounds can be represented by the formula (S)ₙ—O—R wherein S is a sugar moiety such as glucose, fructose, mannose, and galactose; n is an integer of from about 1 to about 1000, and R is a C₈-₃₀ alkyl group. Examples of long chain alcohols from which the alkyl group can be derived include decyl alcohol, cetyl alcohol, stearyl alcohol, lauryl alcohol, myristyl alcohol, oleyl alcohol and the like. Commercially available examples of these surfactants include decyl polyglucoside (available as APG 325 CS from Henkel) and lauryl polyglucoside (available as APG 600 CS and 625 CS from Henkel). Further usefull nonionic surfactants aree ethoxylated octyl and nonyl phenols. Particularly suitable non-ionic ethoxylated octyl and nony) phenols include those having from about 7 to about 13 ethoxy groups. Such compounds are commercially available under the trade name Triton® X (Dow Chemical, Midland, Mich.), as well as under the tradename Igepal® (Rhodia, Princeton, N.J.). One exemplary and particularly preferred nonylphenol ethoxylate is Igepal® CO-630.

Still further examples of suitable nonionic surfactants are alkoxy block copolymers, and in particular, compounds based on ethoxy/propoxy block copolymers. Polymeric alkylene oxide block copolymers include nonionic surfactants in which the major portion of the molecule is made up of block polymeric C₂-C₄ alkylene oxides. Such nonionic surfactants, while preferably built up from an alkylene oxide chain starting group, and can have as a starting nucleus almost any active hydrogen containing group including, without limitation, amides, phenols, thiols and secondary alcohols.

Further nonionic surfactants, although not particularly elucidated herein may also be considered for use in the present inventive compositions.

Exemplary useful cationic surfactants include those which provide a germicidal effect to the compositions, of which are especially preferred quaternary ammonium compounds and salts thereof, which may be characterized by the general structural formula: 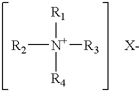
where at least one of R₁, R₂, R₃ and R₄ is a alkyl, aryl or alkylaryl substituent of from 6 to 26 carbon atoms, and the entire cation portion of the molecule has a molecular weight of at least 165. The alkyl substituents may be long-chain alkyl, long-chain alkoxyaryl, long-chain alkylaryl, halogen-substituted long-chain alkylaryl, long-chain alkylphenoxyalkyl, arylalkyl, etc. The remaining substituents on the nitrogen atoms other than the abovementioned alkyl substituents are hydrocarbons usually containing no more than 12 carbon atoms. The substituents R₁, R₂, R₃ and R₄ may be straight-chained or may be branched, but are preferably straight-chained, and may include one or more amide, ether or ester linkages. The counterion X may be any salt-forming anion which permits water solubility of the quaternary ammonium complex.

Exemplary quaternary ammonium salts within the above description include the alkyl ammonium halides such as cetyl trimethyl ammonium bromide, alkyl aryl ammonium halides such as octadecyl dimethyl benzyl ammonium bromide, N-alkyl pyridinium halides such as N-cetyl pyridinium bromide, and the like. Other suitable types of quaternary ammonium salts include those in which the molecule contains either amide, ether or ester linkages such as octyl phenoxy ethoxy ethyl dimethyl benzyl ammonium chloride, N-(laurylcocoaminoformylmethyl)-pyridinium chloride, and the like. Other very effective types of quaternary ammonium compounds which are useful as germicides include those in which the hydrophobic radical is characterized by a substituted aromatic nucleus as in the case of lauryloxyphenyltrimethyl ammonium chloride, cetylaminophenyltrimethyl ammonium methosulfate, dodecylphenyltrimethyl arrunonium methosulfate, dodecylbenzyltrimethyl anunonium chloride, chlorinated dodecylbenzyltrimethyl ammonium chloride, and the like.

Preferred quaternary ammonium compounds which act as germicides and which may be useful in the practice of the present invention include those which have the structural formula: 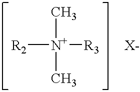
wherein R₂ and R₃ are the same or different C₈-C₁₂alkyl, or R₂ is C₁₂₋₁₆alkyl, C₈₋₁₈alkylethoxy, C₈₋₁₈ alkylphenolethoxy and R₃ is benzyl, and X is a halide, for example chloride, bromide or iodide, or is a methosulfate anion. The alkyl groups recited in R₂ and R₃ may be straight-chained or branched, but are preferably substantially linear.

Particularly usefull quaternary germicides include compositions which include a single quaternary compound, as well as mixtures of two or more different quaternary compounds. Such useful quaternary compounds are available under the BARDAC®, BARQUAT®, HYAMINE®, LONZABAC®, and ONYXIDE® trademarks, which are more fully described in, for example, McCutcheon's Functional Materials (Vol. 2), North American Edition, 1998, as well as the respective product literature from the suppliers identified below. For example, BARDAC® 205M is described to be a liquid containing alkyl dimethyl benzyl ammonium chloride, octyl decyl dimethyl ammonium chloride; didecyl dimethyl ammonium chloride, and dioctyl dimethyl ammonium chloride (50% active) (also available as 80% active (BARDAC® 208M)); described generally in McCutcheon's as a combination of alkyl dimethyl benzyl ammonium chloride and dialkyl dimethyl ammonium chloride); BARDAC® 2050 is described to be a combination of octyl decyl dimethyl ammonium chloridedidecyl dimethyl ammonium chloride, and dioctyl dimethyl ammonium chloride (50% active) (also available as 80% active (BARDAC® 2080)); BARDAC® 2250 is described to be didecyl dimethyl ammonium chloride (50% active); BARDAC® LF (or BARDAC® LF-80), described as being based on dioctyl dimethyl ammonium chloride (BARQUAT® MB-50, MX-50, OJ-50 (each 50% liquid) and MB-80 or MX-80 (each 80% liquid) are each described as an alkyl dimethyl benzyl ammonium chloride; BARDAC® 4250 and BARQUAT® 4250 Z (each 50% active) or BARQUAT® 4280 and BARQUAT 4280Z (each 80% active) are each described as alkyl dimethyl benzyl ammonium chloride/alkyl dimethyl ethyl benzyl ammonium chloride. Also, HYAMINE® 1622, described as diisobutyl phenoxy ethoxy ethyl dimethyl benzyl ammonium chloride (50% solution); HYAMINE® 3500 (50% actives), described as alkyl dimethyl benzyl ammonium chloride (also available as 80% active (HYAMINE® 3500-80)); and HYMAINE® 2389 described as being based on methyldodecylbenzyl ammonium chloride and/or methyldodecylxylene-bis-trimethyl ammonium chloride. (BARDAC®, BARQUAT® and HYAMINE® are presently commercially available from Lonza, Inc., Fairlawn, N.J.). BTC® 50 NF (or BTC® 65 NF) is described to be alkyl dimethyl benzyl ammonium chloride (50% active); BTC® 99 is described as didecyl dimethyl ammonium chloride (50% active); BTC® 776 is described to be myrisalkonium chloride (50% active); BTC® 818 is described as being octyl decyl dimethyl ammonium chloride, didecyl dimethyl ammonium chloride, and dioctyl dimethyl ammonium chloride (50% active) (available also as 80% active (BTC® 818-80%)); BTC® 824 and BTC® 835 are each described as being of alkyl dimethyl benzyl ammonium chloride (each 50% active); BTC® 885 is described as a combination of BTC® 835 and BTC® 818 (50% active) (available also as 80% active (BTC® 888)); BTC® 1010 is described as didecyl dimethyl ammonium chloride (50% active) (also available as 80% active (BTC® 1010-80)); BTC® 2125 (or BTC® 2125 M) is described as alkyl dimethyl benzyl ammonium chloride and alkyl dimethyl ethylbenzyl ammonium chloride (each 50% active) (also available as 80% active (BTC® 2125 80 or BTC® 2125 M)); BTC® 2565 is described as alkyl dimethyl benzyl ammonium chlorides (50% active) (also available as 80% active (BTC® 2568)); BTC® 8248 (or BTC® 8358) is described as alkyl dimethyl benzyl ammonium chloride (80% active) (also available as 90% active (BTC® 8249)); ONYXIDE® 3300 is described as n-alkyl dimethyl benzyl ammonium saccharinate (95% active). (BTC® and ONYXIDE® are presently commercially available from Stepan Company, Northfield, Ill.) Polymeric quaternary ammonium salts based on these monomeric structures are also considered desirable for the present invention. One example is POLYQUAT®, described as being a 2-butenyldimethyl ammonium chloride polymer.

Preferred cationic surfactants which are particularly suited for use in the powdered compositions include BARQUAT® MS-100 described as being alkyl dimethyl benzyl ammonium chloride, as well as HYAMINE® 1622, described as diisobutyl phenoxy ethoxy ethyl dimethyl benzyl ammonium chloride, both of which are available in a solid, or powdered form containing 100% actives of the specific cationic surfactant.

Further cationic surfactants, although not particularly elucidated herein may also be considered for use in the present inventive compositions.

Non-limiting examples of exemplary useful amphoteric surfactants include alkylbetaines, particularly those which may be represented by the following structural formula:
RN(CH₃)₂CH₂COO⁻

wherein R is a straight or branched hydrocarbon chain which may include an aryl moiety, but is preferably a straight hydrocarbon chain containing from about 6 to 30 carbon atoms. Further exemplary usefull amphoteric surfactants include amidoalkylbetaines, such as amidopropylbetaines which may be represented by the following structural formula:
RCONHCH₂CH₂CH₂N⁺(CH₃)₂CH₂COO⁻

wherein R is a straight or branched hydrocarbon chain which may include an aryl moiety, but is preferably a straight hydrocarbon chain containing from about 6 to 30 carbon atoms. Exemplary betaines include dodecyl dimethyl betaine, cetyl dimethyl betaine, dodecyl amidopropyldimethyl betaine, tetradecyldimethyl betaine, tetradecylamidopropyldimethyl betaine, and dodecyldimethylammonium hexanoate.

Further amphoteric and zwitterionic surfactants, although not particularly elucidated herein may also be considered for use in the present inventive compositions.

Preferably the surfactant constituent(s) used in the compositions are provided as an essentially anhydrous or non-hydroscopic compositions which are readily dispersible in water.

Preferred surfactants which may be used in the inventive compositions are anionic surfactants, particularly anionic surfactants which may be provided in an essentially anhydrous or non-hydroscopic composition form and which also exhibit foaming, especially high foaming when combined with water. Such surfactants not only provide an effective cleaning benefit but also provide a desirable aesthetic benefit in that consumers frequently associated superior cleaning with high foaming products.

In certain preferred embodiments, nonionic surfactants are excluded from the compositions.

In further preferred embodiments, cationic surfactants are excluded from the compositions.

In yet further preferred embodiments, both nonionic and cationic surfactants are excluded from the compositions.

In still further preferred embodiments, amphoteric and zwitterionic surfactants are excluded from the compositions.

In a yet further preferred embodiments one or more anionic surfactants are the sole surfactant constituents present in the inventive compositions, and especially preferably wherein the anionic surfactants are one or more of those as exemplified in the following Examples.

The surfactant constituent may be present in any effective amount, however it is preferred that the total amount of any surfactants present be in the range of from about 0.01-30% wt, preferably from about 10-30% wt. based on the total weight of the powdered hard surface cleaning compositions of which they form a part.

With respect to the surfactants which find use in the inventive compositions, it is to be realized that while any surfactant is contemplated to be useful, conveniently surfactants which are substantially anhydrous are most conveniently used as they can be readily used in a dry blending or dry mixing operation. However, surfactants which are supplied in a liquid carrier or medium may also be used, particularly if they are first applied to some of the other components used to produce the powdered compositions, conveniently as a premixture which is formed prior to the final mixing operation or step(s) used to form the inventive compositions. For example, such surfactants supplied in a liquid carrier medium may be first mixed, or sprayed onto one or more of the other powdered compositions which may be used to form a premixture. Such will permit the surfactant to be absorbed or adsorbed onto such materials. Preferably thereafter this premixture is allowed to dry prior to addition to the remaining constituents used to form the powdered compositions. Of course such surfactants may be applied to other of the constituents of the powdered compositions it only being required that the surfactant is substantially non-reactive with such constituent or constituents used for form the premixture. When the formation of a premixture is necessary or convenient, the use of surfactants having lower proportion of liquid carriers to the surfactant are preferred, as less water or other liquid carrier need be absorbed or adsorbed.

The powdered cleaning compositions may include one or more acids, and in certain preferred embodiments an acid constituent is necessarily present. The acid component may be any organic, mineral or inorganic acid, or mixtures thereof. Preferably the acid source is an organic acid. The acid component is preferably substantially anhydrous or non-hygroscopic and the acid is preferably also water-soluble or water dispersible. Exemplary useful organic acids include citric acid, maleic acid, maleic acid, fumaric acid, aspartic acid, glutaric acid, tartaric acid, succinic acid, adipic acid, monosodium phosphate, boric acid, and mixture thereof. Preferred are citric acid, maleic acid, maleic acid, and mixtures, especially citric acid which is both effective and widely commercially available. Citric acid provided in a “coated” form, (e.g, CITROCOAT, ex. Jungbunzlauer, Basel , CH) may also be advantageously used, and in certain preferred embodiments the compositions necessarily include a coated acid, e.g., a coated citric acid.

When an acid constituent is present, it is primarily present as a component of a gas generator system which provides an effervescent effect, namely the evolution of a gas from a liquid resulting from a chemical reaction. This reaction can be between, for example, the acid constituent and an alkali metal carbonate so to produce carbon dioxide gas. Any gas generator system may be used in the compositions of the invention. Preferably the gas generator system comprises both an acid constituent which in the presence of water is capable of reacting with an alkali component which is an alkali or an alkali source in order to produce a gas. Preferably the resultant gas is oxygen, nitrogen dioxide or carbon dioxide but any other gas may also be formed.

As noted the acid constituent, when present, it is primarily present as a component of a gas generator system and while present in sufficient amounts in order to react and generate a gas, preferably the acid constituent is not present in sufficient amounts in order to decrease the pH of the composition by more than about 1 pH point, preferably by not more than about 0.7 pH point. This can be readily determined by producing two compositions, one including an acid constituent and the other in which the acid constituent is omitted, with the weights of the remaining constituents otherwise remaining the same. When added to equal amounts of a larger volume of water, the final pH of the aqueous mixture containing the dissolved/dispersed composition can be evaluated according to normal laboratory methods, e.g, using a standard pH meter and determining the resultant pH of these two similar compositions.

When present, the acid constituent may be present in any effective amount in order to generate a gas as a reaction product as noted above; advantageously the acid constituent is present in amounts of from about 0.01-30% wt, preferably from about 5-30% wt. based on the total weight of the powdered hard surface cleaning compositions of which they form a part.

It is to be particularly noted that in certain alternate preferred embodiments an acid constituent is necessarily excluded from the powdered compositions.

The final pH of the inventive compositions when dispersed/dissolved into a larger volume of water, e.g., 1 part by weight of the powdered composition to 5-30 parts by weight water at 20 deg. C., is alkaline, preferably exhibits a pH of at least about 9, more preferably a pH of at least about 10, yet more preferably a pH of at least about 11.

The addition of one or more anti-caking constituents may improve the dry flow characteristics of the powdered compositions being taught herein. In certain compositions, such anti-caking constituents are optional constituents, in other and in certain preferred embodiments one or more anti-caking constituents are essential constituents.

In order to adjust the bulk density of the powdered compositions it is frequently advantageous to add one or more anti-caking constituents which may be based on water insoluble particulate materials, or which may be water soluble materials in powder or particulate form. The addition of such anti-caking constituents may, depending upon their size, shape and density may be used to adjust the bulk density and the flow properties of the powdered to specific value or to a specific range of values. The addition of one or more such anti-caking constituents frequently is advantageous in improving the dry flow characteristics of the powdered compositions.

By way of non-limiting example, useful anti-caking constituents include water insoluble solid particulate materials. Exemplary water insoluble solid particulate materials include inorganic solid particles such as silica particles including colloidal silicas, fumed silicas, precipitated silicas and silica gels. Non-limiting examples of colloidal silicas include Snowtex C, Snowtex O, Snowtex 50, Snowtex OL, Snowtex ZL available from Nissan Chemical America Corporation and colloidal silicas sold under the tradename Ludox available from W. R. Grace & Co. Non-limiting examples of fumed silicas include hydrophilic and hydrophobic forms available as Aerosil 130, Aerosil 200, Aerosil 300, Aerosil R972 and Aerosil R812 available from Degussa Corp. and those available from Cabot Corp. under the trade name Cab-O-Sil including Cab-O-Sil M-5, HS-5, TS-530, TS-610, and TS-720. Non-limiting examples of precipitated silicas include those available in both hydrophilic and hydrophobic versions from Degussa Corp. under the trade name Sipenat including Sipemat 350, 360, 22LS, 22S, 320, 50S, D10, D11, D17, and C630; those sold by W. R. Grace & Co. under the trade name Syloid, those sold by the J. M. Huber Corp. under the tradename Zeothix and Zeodent, and those available from Rhodia under the trade name Tixosil. Also useful in the present invention are spherical silica solid particles available in various particle sizes and porosities. Non limiting examples of spherical silica solid particles include MSS-500/H, MSS-500/3H, MSS-500, MSS-500/3, MSS-500/N and MSS-500/3N available from KOBO Products Inc.; those available from Presperse Inc. under the trade name Spheron including Spheron P-1500 and L-1500, and those available from Sunjin Chemical Co. under the trade name Sunsil including Sunsil 20, 20L, 20H, 50L, 50, 50H, 130L, 130 and 130H.

The anti-caking constituents may also be one or more water soluble materials in powder or particulate form. Exemplary materials of this type include any soluble inorganic alkali, alkaline earth metal salt or hydrate thereof which however are not primarily used in the gas generator system, including, e.g. chlorides such as sodium chloride, magnesium chloride and the like, sulfates such as magnesium sulfate, copper sulfate, sodium sulfate, zinc sulfate and the like, borax, borates such as sodium borate and the like, as well as others similar materials known to the art but not particularly recited herein. Sodium sulfate is particularly preferred for use as water soluble anti-caking material as it readily dissolves and has little effect on the pH of the water containing the powdered composition when it is dissolved.

A particularly preferred material which is included in the powdered compositions are water soluble carbonates and borates, of which water soluble carbonates, bicarbonates and percarbonates, e.g., alkali and alkaline earth metal carbonates and bicarbonates, such as calcium carbonate and sodium carbonate are particularly advantageously included in the powdered compositions. While these materials are primarily usefull as anti-caking agents a portion of one or more of these materials may also be used in the gas generator system when an acid constituent is also present.

The inventor has surprisingly found that the exclusion of alkali and alkaline earth metal bicarbonates, and the inclusion of water soluble carbonates, especially calcium carbonate provides for improved dry flow properties of the powdered hard surface cleaning compositions, and minimization of caking of the compositions.

The inventor has also surprisingly found that preferred embodiments of the powdered hard surface cleaning compositions according to the invention may be produced which include calcium carbonate and concurrently also excludes known-art anti-caking constituents based on inorganic solid particles which in turn are based on silica particles, including colloidal silicas, fumed silicas, precipitated silicas and silica gels can be omitted from the powdered compositions. In certain particularly preferred embodiments, such anti-caking constituents based on silica particles including colloidal silicas, fumed silicas, precipitated silicas and silica gels are also excluded from the powdered compositions.

The inventor has further surprisingly found that that preferred embodiments of the powdered hard surface cleaning compositions according to the invention may be produced which include calcium carbonate, which concurrently excludes alkali and alkaline earth metal bicarbonates and which also excludes known-art anti-caking constituents based on inorganic solid particles which in turn are based on silica particles, including colloidal silicas, filmed silicas, precipitated silicas and silica gels can be omitted from the powdered compositions.

When present the anti-caking constituent is present in an amount of from about 1-90% wt., preferably from 10-90% wt., based on the total weight of the powdered compositions of which it forms a part. When included, one or more such water insoluble solid particulates may be present in any effective amount in order to adjust the bulk density and/or the dry flow characteristics of the compositions.

Preferred compositions of the invention are powdered compositions which are generally dry free flowing powders with minimal or no tendency to agglomerate or clump. Any such clumps which may form are generally readily broken up by manually lightly striking such a clump. Preferred compositions of the invention are powdered compositions having a bulk density in the range of about 0.5-1.5, preferably in the range of about 0.9-3.1.

The compositions of the present invention can also optionally comprise one or more further constituents which are directed to improving the aesthetic or technical features of the inventive compositions. Such conventional additives known to the art include but not expressly enumerated here may also be included in the compositions according to the invention. By way of non-limiting example without limitation these may include: anti-caking constituents, colorants, fragrances, fillers, dilutents as well as one or more further materials not noted previously. Many of these materials are known to the art, per se, and are described in McCutcheon's Detergents and Emulsifiers, North American Edition, 1998; Kirk-Othmer, Encyclopedia of Chemical Technology, 4th Ed., Vol. 23, pp. 478-541 (1997. Such optional, i.e., non-essential constituents should be selected so to have little or no detrimental effect upon the desirable characteristics of the present invention. When present, the one or more optional constituents present in the inventive compositions do not exceed about 20% wt., preferably do not exceed 15% wt., of the powdered composition of which they form a part.

The powdered hard surface cleaning compositions of the invention optionally but in certain cases desirably includes a fragrance constituent. Fragrance raw materials may be divided into three main groups: (1) the essential oils and products isolated from these oils; (2) products of animal origin; and (3) synthetic chemicals.

The essential oils consist of complex mixtures of volatile liquid and solid chemicals found in various parts of plants. Mention may be made of oils found in flowers, e.g., jasmine, rose, mimosa, and orange blossom; flowers and leaves, e.g., lavender and rosemary; leaves and stems, e.g., geranium, patchouli, and petitgrain; barks, e.g., cinnamon; woods, e.g., sandalwood and rosewood; roots, e.g., angelica; rhizomes, e.g., ginger; fruits, e.g., orange, lemon, and bergamot; seeds, e.g., aniseed and nutmeg; and resinous exudations, e.g., myrrh. These essential oils consist of a complex mixture of chemicals, the major portion thereof being terpenes, including hydrocarbons of the formula (C₅H₈)ₙ and their oxygenated derivatives. Hydrocarbons such as these give rise to a large number of oxygenated derivatives, e.g., alcohols and their esters, aldehydes and ketones. Some of the more important of these are geraniol, citronellol and terpineol, citral and citronellal, and camphor. Other constituents include aliphatic aldehydes and also aromatic compounds including phenols such as eugenol. In some instances, specific compounds may be isolated from the essential oils, usually by distillation in a commercially pure state, for example, geraniol and citronellal from citronella oil; citral from lemon-grass oil; eugenol from clove oil; linalool from rosewood oil; and safrole from sassafras oil. The natural isolates may also be chemically modified as in the case of citronellal to hydroxy citronellal, citral to ionone, eugenol to vanillin, linalool to linalyl acetate, and safrol to heliotropin.

Animal products used in perfumes include musk, ambergris, civet and castoreum, and are generally provided as alcoholic tinctures.

The synthetic chemicals include not only the synthetically made, also naturally occurring isolates mentioned above, but also include their derivatives and compounds unknown in nature, e.g., isoamylsalicylate, arnylcinnamic aldehyde, cyclamen aldehyde, heliotropin, ionone, phenylethyl alcohol, terpineol, undecalactone, and gamma nonyl lactone.

Fragrance compositions as received from a supplier may be provided as an aqueous or organically solvated composition, and may include as a hydrotrope or emulsifier a surface-active agent, typically a surfactant, in minor amount. Such fragrance compositions are quite usually proprietary blends of many different specific fragrance compounds. However, one of ordinary skill in the art, by routine experimentation, may easily determine whether such a proprietary fragrance composition is compatible in the powdered compositions of the present invention.

Advantageously when a fragrance composition is incorporated into the powdered compositions it is either supplied in a powdered form, e.g., FIRCRYST (ex. Firmenich) which includes solid phase fragrance compositions, or may be supplied as a liquid composition. Advantageously when supplied as a liquid composition the fragrance composition is either first adsorbed or absorbed, e.g, by spraying onto a powdered carrier material such as a silica, fumed silica, or zeolite and thereafter supplied as a component to the pulverent compositions of the invention. Alternately and similarly advantageously when the fragrance composition is supplied as a liquid composition it is adsorbed or absorbed onto one of the other constituents used to form the inventive compositions, either during or preferably prior to mixing of the constituents together to form the inventive compositions.

When included, the fragrance composition may be present in any effective amount. Advantageously the fragrance composition comprises up to 3% wt., more preferably from 0.001-2% wt. based on the total weight of the powdered compositions of which they form a part.

Optionally but in some cases advantageously the powdered hard surface cleaning compositions of the invention include a colorant, which may be one or more dyes adsorbed or absorbed onto a pulvurent carrier material such as described above with reference to the fragrance composition, or which may be one or various organic and inorganic pigments. The organic pigments are generally various aromatic types including azo, indigoid, triphenylmethane, anthraquinone, and xanthine dyes which are designated as D&C and FD&C blues, browns, greens, oranges, reds, yellows, etc. Exemplary organic pigments generally consist of insoluble metallic salts of certified color additives formed from dyestuff “lakes” Exemplary inorganic pigments include iron oxides, ultramarine and chromium or chromium hydroxide colors, and mixtures thereof.

When included, the colorant may be present in any effective amount. 25 Advantageously the colorant comprises up to 3% wt., more preferably from 0.001-2% wt. based on the total weight of the powdered compositions of which they form a part.

The powdered hard surface cleaning compositions may also include one or more constituents which may for example be corrosion inhibitors including those based on inorganic materials, e.g., silicates and metasilicates in the form of water soluble salts, 30 such as alkaline and alkaline earth metal salts. One such material which provides good corrosion resistance against metallic surfaces, especially iron surfaces is sodium metasilicate pentahydrate. When present such corrosion inhibitors may be present in any advantageous amount, but are advantageously present in amounts of from about 0.01-1.5% wt.

The powdered compositions may be formed by dry blending of the constituent using conventional apparatus in order to provide a homogenous physical blend of the constituents. Optionally, when a fragrance constituent is used it is first adsorbed or absorbed onto a pulverent carrier material in a separate premix or preblend, and subsequently added to the remaining constituents used to form the powdered compositions of the invention.

The powdered compositions are conveniently packaged into recloseable containers which permit for the convenient removal of measured quantities of the compositions just prior to their use. A resealable tub orjar with a sealable lid is one form of a recloseable container useful with the powdered compositions. Preferably the recloseable container can be sufficiently sealed to provide a vapor barrier between the contents of the container and the ambient environment so to minimize the exposure of the powdered compositions to humid ambient air.

The powdered compositions are particularly useful in the cleaning of hard surfaces. Hard surfaces which are to be particularly denoted are lavatory fixtures, lavatory appliances (toilets, bidets, shower stalls, bathtubs and bathing appliances), wall and flooring surfaces especially those which include refractory materials and the like. Further hard surfaces which are particularly denoted are those associated with dishwashers, kitchen environments and other environments associated with food preparation. Hard surfaces which are those associated with hospital environments, medical laboratories and medical treatment environments. Such hard surfaces described above are to be understood as being recited by way of illustration and not be way of limitation.

### EXAMPLES

Exemplary powdered compositions according to the invention were produced by dry blending measured amounts of specific constituents by use of a conventional laboratory tumble blender for dry powdered materials. In certain examples a fragrance constituent, supplied as a liquid composition may have been absorbed or adsorbed onto a powdered carrier material prior to addition to the constituents. Although the order of addition is usually not critical, in the formation of the examples of Table 2, the acid constituent, sodium sulfate and any hydrophilic materials were first supplied to the blender and allowed to mix about 15 minutes until the blend was homogenous in appearance. Next, the remaining constituents were added, and dry blending was resumed a further 15 minutes until the final powered composition was homogenous in appearance. Typically the total blending time will vary upon the size and type of the mixing equipment used, and the quantity of the materials to be mixed or blended. It is only required that the blending until a powdered composition having a well mixed, generally homogenous appearance is produced.

Exemplary acid containing powdered compositions are described on the following Table 1, and exemplary acid excluding powdered compositions are described on the following Table 2; the amounts of each constituent in each formulation is reported in weight percent and as all constituents were provided in anhydrous form, (or in the case of certain fragrance constituents which were rendered into a powered form,) each of the constituents are presumed to be 99%-100% wt. actives. The total amount of each formulation formed was 100% wt.

TABLE 1

| | E1 | E2 | E3 | E4 | E5 | E6 | E7 | E8 | E9 | E10 | E11 |
|---|---|---|---|---|---|---|---|---|---|---|---|
| sodium carbonate | 30 | 30 | 30 | 20 | 30 | 25 | 25 | 36 | 30 | 38.5 | 30 |
| citric acid | 5 | 10 | 15 | 20 | 25 | 20 | 10* | 20 | 30 | 20 | 15 |
| sodium percarbonate | 20 | 20 | 20 | 20 | 20 | 20 | 20 | 20 | 20 | 20 | 20 |
| dodecylbenzene sulfonate, sodium | 15 | 15 | 15 | 15 | 15 | 15 | 21 | 12 | 12 | 14 | 14 |
| salt (powder) | | | | | | | | | | | |
| sodium metasilicate pentahydrate | 1 | 1 | 1 | 1 | 1 | 1 | 1 | 10 | 6 | 6 | 6 |
| calcium carbonate | 2 | 2 | 2 | 2 | 2 | 2 | 2 | 1 | 1 | 1 | 1 |
| colored silicate | 0.5 | 0.5 | 0.5 | 0.5 | 0.5 | 0.5 | 0.5 | 0.5 | 0.5 | — | — |
| sodium sulfate | 26 | 26 | 21 | 16 | 11 | 6 | 10 | — | — | — | 28.5 |
| sodium chloride | — | — | — | 10 | — | 10 | 10 | — | — | — | — |
| fragrance | 0.5 | 0.5 | 0.5 | 0.5 | 0.5 | 0.5 | 0.5 | 0.5 | 0.5 | 0.5 | 0.5 |

*= denotes uncoated citric acid was used

TABLE 2

| | E12 | E13 | E14 |
|---|---|---|---|
| sodium carbonate | 25 | 35 | 38.5 |
| sodium percarbonate | 20 | 20 | 20 |
| dodecylbenzene sulfonate, sodium | 26 | 15 | 14 |
| salt (powder) | | | |
| sodium metasilicate pentahydrate | 1 | 1 | 6 |
| calcium carbonate | 2 | 2 | 1 |
| colored silicate | 0.5 | 0.5 | — |
| sodium sulfate | 15 | 26 | 20 |
| sodium chloride | 10 | — | — |
| fragrance | 0.5 | 0.5 | 0.5 |

The identity of the constituents used to form the foregoing compositions is recited in the following Table 3.

TABLE 3

| | |
|---|---|
| sodium carbonate | sodium carbonate, anhydrous |
| citric acid | provided as either anhydrous citric acid, |
| | laboratory grade ex. ADM Inc, or as |
| | coated citric acid, CITROCOAT, ex. |
| | Jungbunzlauer, Basel, CH |
| sodium percarbonate | coated sodium percarbonate |
| dodecylbenzene sulfonate, | supplied as NACCONOL 90G, anhydrous |
| sodium salt (powder) | (99-100% wt. actives) |
| sodium metasilicate | sodium metasilicate pentahydrate |
| pentahydrate | |
| calcium carbonate | calcium carbonate |
| colored silicate | colored layered silicate, supplied as SKS- |
| | 6 Blue |
| sodium sulfate | sodium sulfate |
| sodium chloride | sodium chloride |
| fragrance | proprietary composition |

Each of the compositions according to Table 1 and Table 2 were dry, free flowing powder compositions.

Cleaning:

The cleaning efficacy of certain of the compositions described on Table 1 and Table 2 were compared against certain commercially available powdered hard surface cleaning products.

Cleaning testing was performed generally in accordance with the protocol of the ASTM D-4488-95 A2 Greasy Soil/Painted Masonite Wallboard Test Method.

Twelve 4″×4″ Masonite tiles were taken and cleaned with dry paper towel to remove any dust or particle. Tiles were laid flat on the lab bench with smooth side up.

Tiles were then painted with white paint. Once the tiles were dry and second coat was applied. The painted tiles were then let dry overnight. After 24 hours of drying time the tiles were soiled.

A standardized test soil containing natural humus, paraffin oil, used crankcase 20 motor oil, Portland cement, silica, lampblack carbon, iron oxide, bandy black clay, stearic acid, and oleic acid was produced according to ASTM Method D4488 (A2) and heated to 100 deg. F. in a water bath and mixed with a magnetic stirrer for about 30 minutes until uniform. Using a folded cheese cloth the prepared soil was applied onto the white painted tile by applying six strokes of the cheese cloth immersed in the prepared soil. This process was repeated to soil all twelve tiles. The soiled tiles were thereafter air dried at room temperature for 24 hours.

Samples of the test compositions were thereafter prepared. Standard stock solutions of each powdered hard surface cleaning composition were produced by dissolving 60 grams of each in 5 litres of deionized water in a plastic pail and slowly hand mixed until all powder was dissolved. A total of five such stock solutions were prepared based on the following materials:

Comp.1: E12

Comp.2: E6

Comp.3: “Spic & Span” (ex. MF Distribution Inc., Concord, Ontario, Canada)

Comp.4: “OxiClean Miracle Foam Power Cleaner” (ex. Orange Glo International, Inc., Littleton, Colo., USA)

Comp.5: “Easy-Off BAM Power Clean Crystals” (ex. Reckitt Benckiser plc, United Kingdom) the latter three compositions being powdered hard surface cleaning products which are presently commercially available.

Each of the soiled tiles were divided into two sides by applying strip of a half inch wide masking tape bisecting the soiled surface of the tile, thereby enabling to test two products on one tile.

To perform the test, a soiled tile was then placed in a BYK Gardner Abrasion Tester (ex. Gardner Laboratory, Silver Spring, Md., USA) and secured to the tray with two clamps, such that the path of the sponge would traverse one side of the tile surface without however traversing the masking tape strip. The Gardner Tester was set to a 20 stroke cycle. Next, two aliquots of a stock solution being tested using the tile were provided clean graduated cylinders. Thereafter, a clean washed sponge was taken and inserted into the sponge holder. First, the 50 ml sample of a stock solution was poured onto the sponge. Next, the contents of the 10 ml graduated cylinder, namely the 5 ml of the same stock solution being tested was poured onto one side of the soiled tile and was permitted to contact the soiled surface of the tile at rest for 60 seconds. Subsequently the Gardner machine was turned on to cycle 20 times, after which the Gardner Tester stopped automatically. The treated tile was removed from the clamp and the cleaned area was rinsed with deionized water. The tile was then removed, and repositioned in the Gardner Tester such that the path of the sponge would traverse the non-treated (uncleaned) soiled side of the tile without however traversing the masking tape strip. The foregoing test steps were repeated using however a sample of a stock solution based on Comp. 3 which was used clean this second side of the tile surface. In this manner, each tile tested was cleaned with two different stock solutions, with one of the tile surfaces being cleaned using the stock solution based on Comp. 3. This foregoing procedure was repeated with all twelve tiles and using all five stock solutions.

The cleaning efficacy of the stock solutions were evaluated for percent soil removed using a Minolta ChromaMeter CR-300. A scale rating was established whereby the endpoints of the scale corresponded to 0% soil removed to 100% soil removed.

The twelve tiles were tested as indicated above were evaluated. ANOVA—One Way Analysis of Variance Model (Tukey's pairwise comparisons) was performed on the percent soil removal obtained from the instrumental readings. The results of these evaluations are reported in the following Table A.

TABLE A

| | number of tile | | |
|---|---|---|---|
| | surfaces treated | statistical Mean | |
| stock solution | and analyzed | value | standard deviation |
| Comp. 1 | 3 | 79.95 | 8.18 |
| Comp. 2 | 3 | 45.36 | 4.38 |
| Comp. 3 | 12 | 56.94 | 11.33 |
| Comp. 4 | 3 | 33.02 | 12.37 |
| Comp. 5 | 3 | 39.82 | 5.31 |

As can be seen from the foregoing results, the compositions provided comparable or superior cleaning results compared to the commercially available compositions.

While described in terms of the presently preferred embodiments, it is to be understood that the present disclosure is to be interpreted as by way of illustration, and not by way of limitation, and that various modifications and alterations apparent to one skilled in the art may be made without departing from the scope and spirit of the present invention.

1. Powdered hard surface cleaning compositions comprise one or more surfactants especially anhydrous or powdered anionic surfactants providing good foaming, calcium carbonate, and which exclude one or both of:
alkali or alkali metal bicarbonates;
known-art anti-caking constituents based on silica particles including colloidal silicas, fumed silicas, precipitated silicas and silica gels.

2. Powdered hard surface cleaning compositions according the claim 1 which include an alkali or alkali metal carbonate.

3. Powdered hard surface cleaning compositions according to claim 2 which exclude:
alkali or alkali metal bicarbonates.

4. Powdered hard surface cleaning compositions according to claim 2 which exclude:
known-art anti-caking constituents based on silica particles including colloidal silicas, fumes silicas, precipitated silicas and silica gels.

5. Powdered hard surface cleaning compositions according to claim 2 which exclude both:
alkali or alkali metal bicarbonates;
known-art anti-caking constituents based on silica particles including colloidal silicas, fumed silicas, precipitated silicas and silica gels.
